(19) United States
(12) Patent Application Publication
(10) Pub. No.: US 2026/0100169 A1
(43) Pub. Date: Apr. 9, 2026

(54) ELECTRONIC DEVICE AND DRIVING METHOD THEREOF

(71) Applicant: InnoLux Corporation, Miao-Li County (TW)

(72) Inventors: Cheng-Ze LIN, Miao-Li County (TW); Hong-Sheng HSIEH, Miao-Li County (TW); Chih-Yung HSIEH, Miao-Li County (TW); Kuan-Ting TUNG, Miao-Li County (TW)

(21) Appl. No.: 19/328,404

(22) Filed: Sep. 15, 2025

Related U.S. Application Data
(60) Provisional application No. 63/704,186, filed on Oct. 7, 2024.

(30) Foreign Application Priority Data
Mar. 11, 2025 (CN) 202510282048.4

(51) Int. Cl. G09G 3/34

(52) U.S. Cl. CPC G09G 3/3426; G09G 2320/0626; G09G 2320/068; G09G 2360/144

(57) ABSTRACT

A driving method of an electronic device includes: providing an electronic device including a panel, a partition-driven backlight module, and an privacy-adjustable element, wherein the privacy-adjustable element is disposed on one side of the partition-driven backlight module, the panel is disposed on one side of the privacy-adjustable element, and the privacy-adjustable element is capable of being switched to a privacy mode or a sharing mode; and providing a detector for detecting a brightness of ambient light or a contrast of the electronic device, wherein, when the privacy-adjustable element is switched to the sharing mode, the partition-driven backlight module turns on a partition dimming function, wherein, when the privacy-adjustable element is switched to the privacy mode, the partition-driven backlight module turns on or off the partition dimming function according to the brightness of ambient light or the contrast of the electronic device.

### CROSS-REFERENCE TO RELATED APPLICATIONS

This application claims the benefit of filing date of U.S. Provisional Application Ser. No. 63/704,186 filed on Oct. 7, 2024 under 35 USC § 119(e)(1), and also claims the benefit of the Chinese Patent Application Serial Number 202510282048.4, filed on Mar. 11, 2025, the subject matters of which are incorporated herein by reference.

### BACKGROUND

### Field of the Disclosure

The present disclosure relates to an electronic device and a driving method thereof and, more particularly, to an electronic device including a partition-driven backlight module and a privacy-adjustable element, and a driving method thereof.

### Description of Related Art

With the advance of science and technology, the technology of electronic devices continues to improve. In order to meet consumers'requirements for display quality of electronic devices, all manufacturers are committed to improving the development of display quality of electronic devices.

However, current electronic devices are easily affected by external environments such as ambient light, resulting in that electronic devices still have display quality problems such as poor contrast. Therefore, it is desired to provide an electronic device and a driving method thereof to alleviate and/or obviate the above defects so as to enhance the display quality.

### SUMMARY

The present disclosure provides a driving method of an electronic device, which includes: providing an electronic device including a panel, a partition-driven backlight module, and an privacy-adjustable element, wherein the privacy-adjustable element is disposed on one side of the partition-driven backlight module, the panel is disposed on one side of the privacy-adjustable element, the partition-driven backlight module has a partition dimming function, and the privacy-adjustable element is capable of being switched to a privacy mode or a sharing mode; and providing a detector for detecting a brightness of ambient light or a contrast of the electronic device, wherein, when the privacy-adjustable element is switched to the sharing mode, the partition-driven backlight module turns on the partition dimming function, wherein, when the privacy-adjustable element is switched to the privacy mode, the partition-driven backlight module turns on or turns off the partition dimming function according to the brightness of ambient light or the contrast of the electronic device detected by the detector.

The present disclosure further provides an electronic device, which includes a partition-driven backlight module; a privacy-adjustable element disposed on one side of the partition-driven backlight module, wherein the privacy-adjustable element is capable of being switched to a privacy mode and a sharing mode; and a panel disposed on one side of the privacy-adjustable element.

Other novel features of the disclosure will become more apparent from the following detailed description when taken in conjunction with the accompanying drawings.

### BRIEF DESCRIPTION OF DRAWINGS

FIG. 1 is a schematic diagram of an electronic device according to an embodiment of the present disclosure;

FIG. 2 is a schematic diagram of an electronic device according to an embodiment of the present disclosure;

FIG. 3 is a schematic diagram of an electronic device according to an embodiment of the present disclosure;

FIG. 4 is a schematic diagram of a portion of an electronic device according to an embodiment of the present disclosure;

FIG. 5 is a schematic diagram of a portion of an electronic device according to an embodiment of the present disclosure;

FIG. 6A is a block diagram of a driving method of an electronic device according to an embodiment of the present disclosure;

FIG. 6B to FIG. 6D are schematic diagrams of electronic devices according to different implementation aspects of the present disclosure;

FIG. 7A is a block diagram of a driving method of an electronic device according to an embodiment of the present disclosure;

FIG. 7B and FIG. 7C are schematic diagrams showing a detector detecting the contrast of an electronic device according to an embodiment of the present disclosure; and

FIG. 8 is a schematic diagram of an electronic device according to another embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures. In the present disclosure, the term “correspondingly disposed” or “disposed corresponding to” refers to, for example, that the components substantially overlap each other, but the present disclosure is not limited thereto.

In addition, it should be understood that, unless otherwise specified, the ordinal numbers used in the specification and claims, such as “first” and “second”, are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

Furthermore, according to the embodiments of the present disclosure, an optical microscope (OM), a scanning electron microscope (SEM), an thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and appended claims of the present disclosure, certain words are used to refer to specific components. Those skilled in the art should understand that electronic device manufacturers may refer to the same components by different names. The present disclosure does not intend to distinguish those components with the same function but different names. In the following description and claims, words such as “comprising”, “including”, and “having” are open type words, so they should be interpreted as meaning “including but not limited to”. Therefore, when the terms “comprising”, “including” and/or “having” are used in the description of the present disclosure, they specify the existence of corresponding features, regions, steps, operations and/or components, but do not exclude the existence of one or more corresponding features, regions, steps, operations and/or components.

It should be understood that, without departing from the spirit of the present disclosure, in the following embodiments, the features in different embodiments may be replaced, reorganized or mixed to accomplish other embodiments. The features among various embodiments may be mixed and matched arbitrarily as long as they do not violate the spirit of the invention or conflict with each other.

It should be noted that the following embodiments may be implemented by replacing, reorganizing, or mixing the features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments may be replaced, combined or mixed with each other to form another embodiment without violating the spirit of the present disclosure.

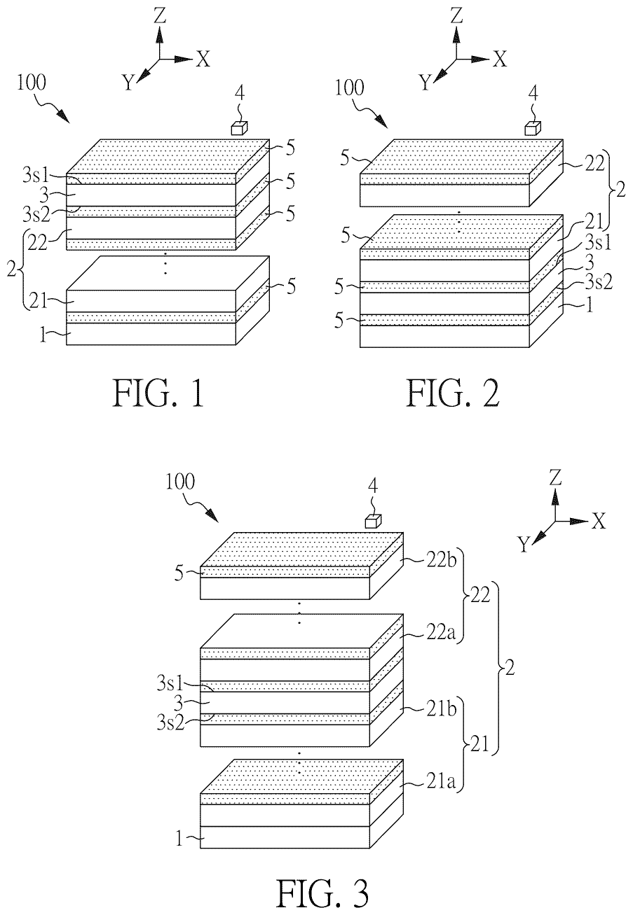

FIG. 1 is a schematic diagram of an electronic device according to an embodiment of the present disclosure.

In one embodiment of the present disclosure, as shown in FIG. 1, the electronic device 100 may include: a partition-driven backlight module 1; a privacy-adjustable element 2, which is arranged on one side of the partition-driven backlight module 1, wherein the privacy-adjustable element 2 may be switched between a privacy mode and a sharing mode; and a panel 3, which is arranged on one side of the privacy-adjustable element 2. The present disclosure enables the electronic device 100 to be switched between a privacy mode and a sharing mode through the use of the privacy-adjustable element 2. In addition, by cooperating with the partition-driven backlight module 1 to turn on or turn off the partition dimming function, the contrast of the electronic device 100 may be improved and/or the halo effect thereof may be reduced to improve the display quality and/or achieve power saving effects.

In the present disclosure, the partition-driven backlight module 1 may selectively include a substrate, a light source, a light guide plate, an optical film, a reflective sheet, a frame, other suitable components or a combination thereof, but the present disclosure is not limited thereto. The light source may include a light emitting diode, but the present disclosure is not limited thereto. The optical film may include a prism, a brightness enhancement film, a diffuser, other optical films, or a combination thereof, but the present disclosure is not limited thereto.

In the present disclosure, the privacy-adjustable element 2 may include a liquid crystal unit. The liquid crystal unit may include a light modulation layer, and a substrate and an electrode layer disposed on two sides of the light modulation layer. By applying a signal to the electrode layer to control the light modulation layer, the privacy-adjustable element 2 may be switched between a privacy mode and a sharing mode. In the present disclosure, the liquid crystal unit may be of an electrically controlled bi-fold type, a twisted nematic type, a vertical alignment type, a hybrid alignment type, etc., but the present disclosure is not limited thereto. The light modulation layer may include a suitable liquid crystal material such as polymer-dispersed liquid crystal (PDLC), polymer network liquid crystal (PNLC), other suitable liquid crystal materials or a combination thereof, but the present disclosure is not limited thereto. In one embodiment of the present disclosure, a hybrid alignment type liquid crystal unit, for example, refers to that part of the liquid crystal material in the light modulation layer is vertically aligned, and the other part of the liquid crystal material is horizontally aligned, wherein the vertical alignment, for example, refers to that the pre-tilt angle of the liquid crystal material is 1 degree (□) to 3 degrees (□), and the horizontal alignment, for example, refers to that the pre-tilt angle of the liquid crystal material is 87 degrees (□) to 90 degrees (□), but the present disclosure is not limited thereto.

In the present disclosure, the panel 3 may be a liquid crystal display panel for displaying images or texts. The liquid crystal display panel may include any suitable components, such as a substrate, an electrode layer, an alignment film, an insulating layer, a liquid crystal material, a seal, a light shielding layer, a color filter layer, an electronic component, a circuit board, a driving component, other suitable components or a combination thereof, but the present disclosure is not limited thereto. The electronic components may include passive components and active components, such as capacitors, resistors, inductors, diodes, transistors, etc., but the present disclosure is not limited thereto. In one embodiment of the present disclosure, as shown in FIG. 1, the panel has a display side 3s1 and a non-display side 3s2 opposite to the display side 3s1, wherein the display side 3s1 is farther away from the partition-driven backlight module 1 relative to the non-display side 3s2.

In one embodiment of the present disclosure, the electronic device 100 may further include a detector 4, which is disposed adjacent to the panel 3 or the privacy-adjustable element 2, and the detector 4 is used to detect a brightness of ambient light or a contrast of the electronic device 100. In more detail, as shown in FIG. 1, the detector 4 may be disposed adjacent to the panel 3, and adjacent to one side of the panel 3 away from the partition-driven backlight module 1. In one embodiment of the present disclosure, the detector 4 is disposed adjacent to the display side 3s1 of the panel 3, that is, the display side 3s1 of the panel 3 is adjacent to the detector 4 relative to the non-display side 3s2. The electronic device 100 disclosed in the present invention may detect the brightness of ambient light or the contrast of the electronic device 100 through the detector 4 so as to determine whether to turn on or turn off the partition dimming function of the partition-driven backlight module 1, thereby improving the display quality of the electronic device 100. In the present disclosure, the detector 4 includes a sensing element capable of detecting the brightness of ambient light or the contrast of the electronic device 100.

In one embodiment of the present disclosure, as shown in FIG. 1, the privacy-adjustable element 2 is disposed on the partition-driven backlight module 1, and the privacy-adjustable element 2 is disposed between the panel 3 and the partition-driven backlight module 1, but the present disclosure is not limited thereto. In one embodiment of the present disclosure, as shown in FIG. 1, the privacy-adjustable element 2 may selectively include multiple portions, such as a first portion 21 and a second portion 22, wherein the second portion 22 may be disposed on the first portion 21, and both the first portion 21 and the second portion 22 are disposed between the panel 3 and the partition-driven backlight module 1. In the present disclosure, the first portion 21 and the second portion 22 of the privacy-adjustable element 2 may each include a liquid crystal unit as described above, which will not be described in detail herein. In the present disclosure, the privacy-adjustable element 2 in FIG. 1 is illustrated with two portions (that is, a first portion 21 and a second portion 22), but the present disclosure is not limited thereto. In other embodiments, the number of portions may be adjusted (for example, increased or decreased) as needed.

By combining multiple portions of the privacy-adjustable element 2, the contrast of the electronic device 100 may be increased or the privacy mode effect of the privacy-adjustable element 2 may be improved.

In one embodiment of the present disclosure, as shown in FIG. 1, the electronic device 100 may selectively include multiple polarizing plates 5, and the polarizing plates 5 may selectively be disposed on two sides of the panel 3, on two sides of the privacy-adjustable element 2, between the panel 3 and the privacy-adjustable element 2, between the first portion 21 and the second portion 22 of the privacy-adjustable element 2, between the privacy-adjustable element 2 and the partition-driven backlight module 1, or a combination thereof, but the present disclosure is not limited thereto. The polarizing plate 5 may be used to improve the display quality of the electronic device 100.

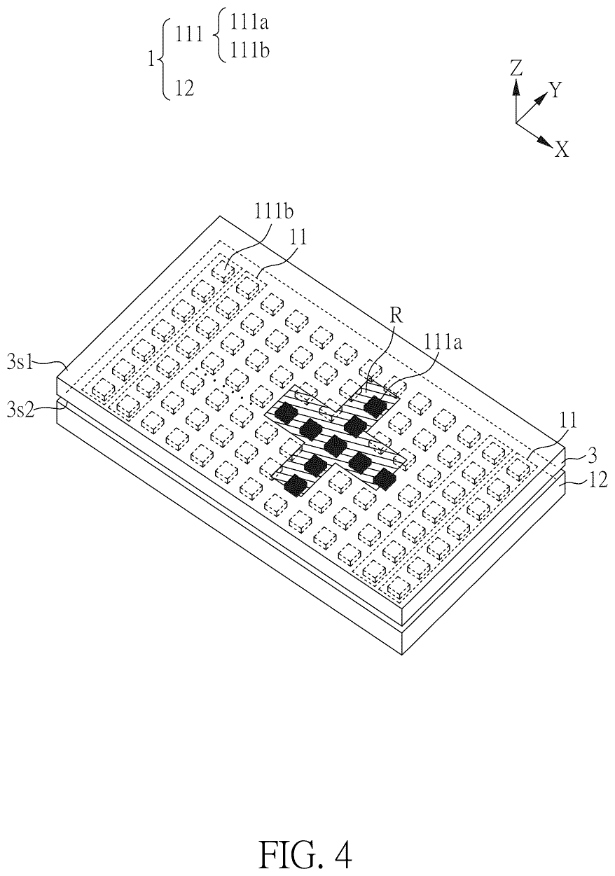

FIG. 2 is a schematic diagram of an electronic device according to an embodiment of the present disclosure. The electronic device of FIG. 2 is similar to that of FIG. 1 except for the following differences.

In one embodiment of the present disclosure, as shown in FIG. 2, the panel 3 is disposed on the partition-driven backlight module 1, and the panel 3 is disposed between the privacy-adjustable element 2 and the partition-driven backlight module 1. In addition, the detector 4 may be disposed adjacent to the privacy-adjustable element 2, and adjacent to one side of the privacy-adjustable element 2 away from the partition-drivable backlight module 1.

In the present disclosure, the detailed features of the partition-driven backlight module 1, the privacy-adjustable element 2, the panel 3, the detector 4 and the polarizing plate 5 may be as described above and will not be repeated here. In addition, other detailed features of the electronic device 100 may also be as described above and will not be repeated here.

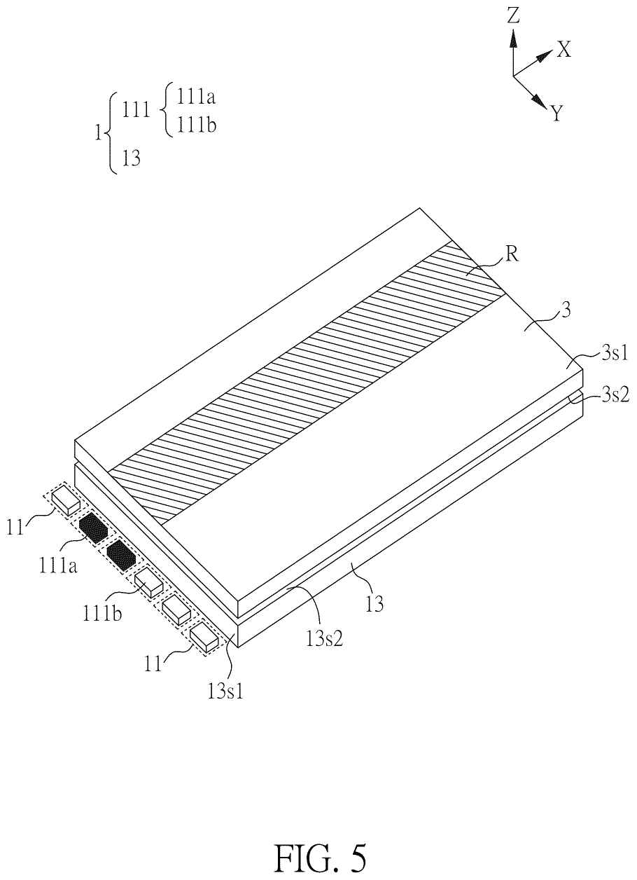

FIG. 3 is a schematic diagram of an electronic device according to an embodiment of the present disclosure. The electronic device of FIG. 3 is similar to that of FIG. 1, except for the following differences.

In one embodiment of the present disclosure, as shown in FIG. 3, the privacy-adjustable element 2 includes a first portion 21 and a second portion 22, which are respectively disposed on two sides of the panel 3. In more detail, the first portion 21 of the privacy-adjustable element 2 may be disposed between the partition-drivable backlight module 1 and the panel 3, and the panel 3 may be disposed between the first portion 21 and the second portion 22 of the privacy-adjustable element 2.

In one embodiment of the present disclosure, as shown in FIG. 3, the first portion 21 of the privacy-adjustable element 2 may selectively include multiple sub-portions, such as a first sub-portion 21a and a second sub-portion 21b, wherein the second sub-portion 21b may be arranged on the first sub-portion 21a, and the first sub-portion 21a and the second sub-portion 21b are both arranged between the partition-driven backlight module 1 and the panel 3. Similarly, as shown in FIG. 3, the second portion 22 of the privacy-adjustable element 2 may also selectively include multiple sub-portions, such as a third sub-portion 22a and a fourth sub-portion 22b, wherein the fourth sub-portion 22b may be arranged on the third sub-portion 22a, and the third sub-portion 22a is arranged between the panel 3 and the fourth sub-portion 22b. In the present disclosure, the first sub-portion 21a, the second sub-portion 21b, the third sub-portion 22a and the fourth sub-portion 22b of the privacy-adjustable element 2 may each include a liquid crystal unit as described above, which will not be described in detail herein. In the present disclosure, the first portion 21 of the privacy-adjustable element 2 in FIG. 3 is illustrated with two sub-portions (that is, the first sub-portion 21a and the second sub-portion 21b), but the present disclosure is not limited thereto. In other embodiments, the number of sub-portions may be adjusted (for example, increased or decreased) as needed. Similarly, the second portion 22 of the privacy-adjustable element 2 in FIG. 3 is illustrated with two sub-portions (that is, the third sub-portion 22a and the fourth sub-portion 22b), but the present disclosure is not limited thereto. In other embodiments, the number of sub-portions may be adjusted (for example, increased or decreased) as needed. By combining the privacy-adjustable element 2 with multiple sub-portions, the contrast of the electronic device 100 may be increased or the privacy mode effect of the privacy-adjustable element 2 may be improved.

In one embodiment of the present disclosure, as shown in FIG. 3, the detector 4 may be disposed adjacent to the privacy-adjustable element 2. In more detail, the detector 4 may be disposed adjacent to the fourth sub-portion 22b of the second portion 22 of the privacy-adjustable element 2, and is disposed on one side of the panel 3 away from the partition-driven backlight module 1 (for example, the display side 3s1 of the panel 3).

In one embodiment of the present disclosure, as shown in FIG. 3, the electronic device 100 may selectively include multiple polarizing plates 5, and the polarizing plates 5 may selectively be arranged on two sides of the panel 3, on two sides of the privacy-adjustable element 2, between the panel 3 and the first portion 21 of the privacy-adjustable element 2, between the panel 3 and the second portion 22 of the privacy-adjustable element 2, between the first sub-portion 21a and the second sub-portion 21b of the privacy-adjustable element 2, between the third sub-portion 22a and the fourth sub-portion 22b of the privacy-adjustable element 2, or a combination thereof, but the present disclosure is not limited thereto. The polarizing plate 5 may be used to improve the display quality of the electronic device 100.

In the present disclosure, the detailed features of the partition-driven backlight module 1, the privacy-adjustable element 2, the panel 3, the detector 4 and the polarizing plate 5 may be as described above and will not be repeated here. In addition, other detailed features of the electronic device 100 may also be as described above and will not be repeated here.

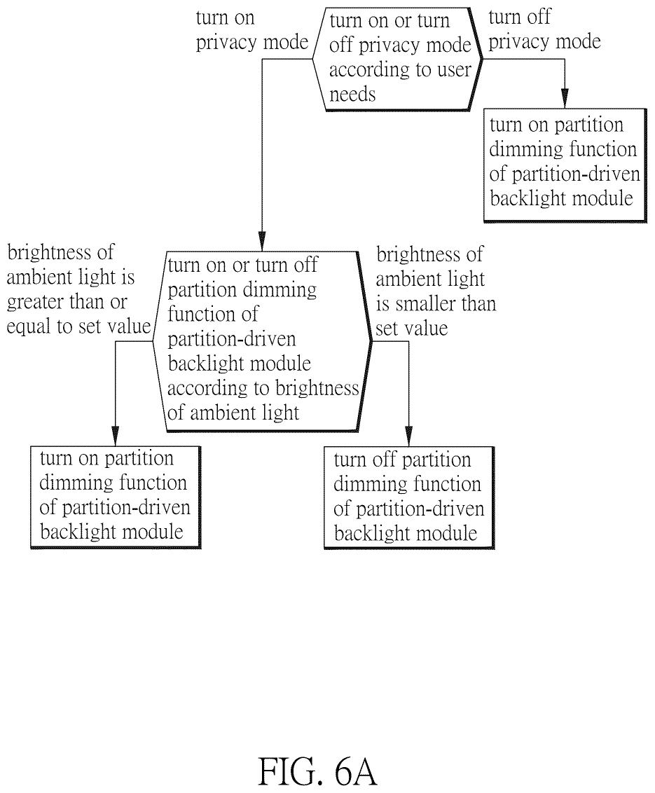

FIG. 4 is a schematic diagram of a portion of an electronic device according to an embodiment of the present disclosure. In FIG. 4, the black solid pattern represents the turn-on light emitting unit 111a, and the white blank pattern represents the turn-off light emitting unit 111b. In addition, some elements are omitted in the figure for convenience of explanation.

In one embodiment of the present disclosure, as shown in FIG. 4, the partition-driven backlight module 1 may include multiple adjustment sections 11, and the multiple adjustment sections 11 each include at least one light emitting unit 111, wherein, when the privacy-adjustable element 2 (as shown in FIG. 1) is switched to the sharing mode, the partition-driven backlight module 1 turns on the partition dimming function, and at least one light emitting unit 111 (for example, the light emitting unit 111a) among the multiple adjustment sections 11 corresponding to a display screen area R of the panel 3 is turned on, while at least one light emitting unit 111 (for example, the light emitting unit 111b) among the multiple adjustment sections 11 not corresponding to the display screen area R of the panel 3 is not turned on.

In more detail, in one embodiment of the present disclosure, as shown in FIG. 4, the partition-driven backlight module 1 may be, for example, a direct-type backlight module. Therefore, when the partition-driven backlight module 1 turns on the partition dimming function, in the normal direction Z of the panel 3, at least one light emitting unit 111 (for example, the light emitting unit 111a) in the adjustment section 11 that at least partially overlaps with the display screen area R is turned on, and at least one light emitting unit 111 (for example, the light emitting unit 111b) in the adjustment section 11 that does not overlap with the display screen area R is turned off. In this way, the partition dimming function of the partition-driven backlight module 1 may be realized. In the present disclosure, since the partition-driven backlight module 1 has a partition dimming function, the contrast of the electronic device 100 may be increased and/or the halo effect may be reduced, thereby improving the display quality of the electronic device 100.

In the present disclosure, each adjustment section 11 in FIG. 4 is illustrated as including seven light emitting units 111, but the present disclosure is not limited thereto. In other embodiments, the number or arrangement of the light emitting units 111 may be adjusted (for example, increased or decreased) as needed, and the number or arrangement of the light emitting units 111 in each adjustment section 11 may be the same or different. In the present disclosure, the light emitting unit 111 may include a light emitting diode, which may include, for example, an organic light emitting diode (OLED), a sub-millimeter light emitting diode (mini LED), a micro LED, or a quantum dot light emitting diode (which may include QLED, QDLED), fluorescence, phosphor, other suitable materials, or a combination thereof, but the present disclosure is not limited thereto. In the present disclosure, the display screen area R in FIG. 4 is illustrated by the pattern “+”, but the present disclosure is not limited thereto. In other embodiments, the display screen area R may be any pattern or text.

In one embodiment of the present disclosure, as shown in FIG. 4, the partition-driven backlight module 1 may include a substrate 12, wherein the light emitting unit 111 is disposed on the substrate 12. In the present disclosure, although not shown in the figures, the partition-driven backlight module 1 may selectively include a light guide plate, an optical film, a reflective sheet, a frame, other suitable elements or a combination thereof, but the present disclosure is not limited thereto. The optical film may include a prism, a brightness enhancement film, a diffuser, other optical films, or a combination thereof, but the present disclosure is not limited thereto.

In the present disclosure, the partition-driven backlight module 1 shown in FIG. 1 to FIG. 3 may be, for example, as shown in FIG. 4, but the present disclosure is not limited thereto. In addition, other detailed features of the partition-driven backlight module 1 and the panel 3 are as described above and will not be repeated here.

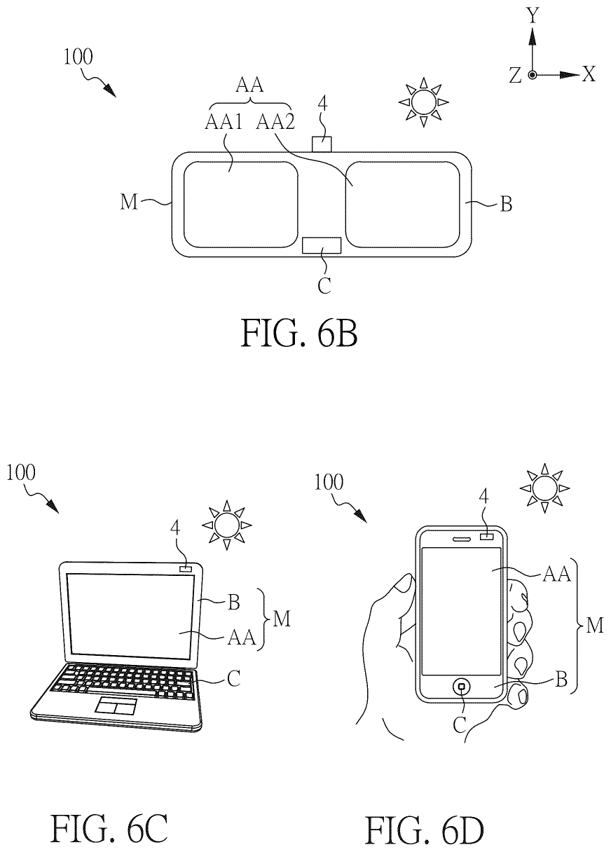

FIG. 5 is a schematic diagram of a portion of an electronic device according to an embodiment of the present disclosure. In FIG. 5, a black solid pattern represents a turn-on light emitting unit 111a, and a white blank pattern represents a turn-off light emitting unit 111b. The partition-driven backlight module 1 of FIG. 5 is similar to that of FIG. 4 except for the following differences. In addition, some components are omitted in the figure for convenience of explanation.

In one embodiment of the present disclosure, as shown in FIG. 5, the partition-driven backlight module 1 may be, for example, an edge-lit backlight module. When the privacy-adjustable element 2 (as shown in FIG. 1) is switched to the sharing mode, the partition-driven backlight module 1 turns on the partition dimming function, and at least one light emitting unit 111 (for example, the light emitting unit 111a) among the multiple adjustment sections 11 corresponding to the display screen area R of the panel 3 is turned on, and at least one light emitting unit 111 (for example, the light emitting unit 111b) among the multiple adjustment sections 11 corresponding to the display screen area R of the panel 3 is not turned on. In this way, the partition dimming function of the partition-driven backlight module 1 can be realized. In the present disclosure, the display screen area R in FIG. 5 is illustrated as a rectangular pattern, but the present disclosure is not limited thereto. In other embodiments, the display screen area R may be any desired pattern or text. In the present disclosure, each adjustment section 11 in FIG. 5 is illustrated as including one light emitting unit 111, but the present disclosure is not limited thereto. The number of light emitting units 111 may be adjusted (for example, increased or decreased) as needed, and the number of light emitting units 111 in each adjustment section 11 may be the same or different.

In one embodiment of the present disclosure, as shown in FIG. 5, the partition-driven backlight module 1 may include a light guide plate 13, and the light guide plate 13 includes a light incident surface 13s1 and a light exiting surface 13s2 connected to the light incident surface 13s1, wherein the light emitting unit 111 is arranged corresponding to the light incident surface 13s1 of the light guide plate 13, and the panel 3 is arranged corresponding to the light existing surface 13s2 of the light guide plate 13. The light provided by the light emitting unit 111 may enter the light guide plate 13 through the light incident surface 13s1 of the light guide plate 13, and may be guided out to the panel 3 by the light exiting surface 13s2 of the light guide plate 13, so that the panel 3 may display an image. In this embodiment, the “light emitting unit 111 corresponding to the display screen area R of the panel 3” refers, for example, to the light emitting unit 111 (for example, the light emitting unit 111a) that affects the image displayed in the display screen area R. More specifically, for example, it refers to light provided by the light emitting unit 111a that is guided to the panel 3 via the light guide plate 13 and, in the normal direction Z of the panel 3, the light may at least partially overlap with the display screen area R, but the present disclosure is not limited thereto. In other embodiments (not shown), the light emitting unit 111 may be disposed on different sides of the light guide plate 13, such as two opposite sides of the light guide plate 13, that is, there may be two light incident surfaces opposite to each other, but the present invention is not limited thereto.

In the present disclosure, the partition-driven backlight module 1 shown in FIG. 1 to FIG. 3 may be, for example, as shown in FIG. 5, but the present disclosure is not limited thereto. In addition, other detailed features of the partition-driven backlight module 1 and the panel 3 are as described above and will not be repeated here.

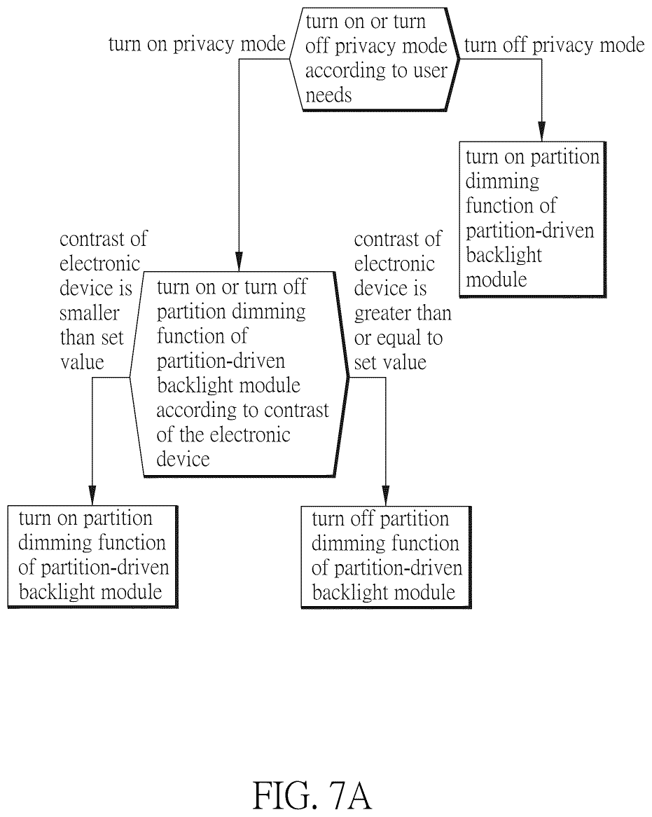

FIG. 6A is a block diagram of a driving method of an electronic device according to an embodiment of the present disclosure. FIG. 6B to FIG. 6D are schematic diagrams of electronic devices according to different implementation aspects of the present disclosure.

In one embodiment of the present disclosure, referring to the electronic device 100 of FIG. 1 to FIG. 3, a driving method of the electronic device 100 may include: providing an electronic device 100, wherein the electronic device 100 includes a panel 3, a partition-driven backlight module 1 and a privacy-adjustable element 2, the privacy-adjustable element 2 is arranged on one side of the partition-driven backlight module 1, the panel 3 is arranged on one side of the privacy-adjustable element 2, the partition-driven backlight module 1 has a partition dimming function, and the privacy-adjustable element 2 may be switched to a privacy mode or a sharing mode (that is, the privacy-adjustable element 2 may be switched between the privacy mode and the sharing mode); and providing a detector 4 for detecting a brightness of ambient light. When the privacy-adjustable element 2 is switched to the sharing mode, the partition-driven backlight module 1 turns on the partition dimming function, and when the privacy-adjustable element 2 is switched to the privacy mode, the partition-driven backlight module 1 turns on or off the partition dimming function according to the brightness of ambient light detected by the detector 4.

In more detail, as shown in FIG. 1 and FIG. 6A, the electronic device 100 of the present disclosure may determine to turn on or turn off the privacy mode according to user needs, that is, the privacy mode of the electronic device 100 may be turned on or turned off by switching the privacy-adjustable element 2 to the privacy mode or the sharing mode. When the privacy-adjustable element 2 is switched to the sharing mode (that is, the electronic device 100 turns off the privacy mode), the electronic device 100 may turn on the partition dimming function of the partition-driven backlight module 1, thereby improving the contrast of the electronic device 100. When the privacy-adjustable element 2 is switched to the privacy mode (that is, the electronic device 100 turns on the privacy mode), the electronic device 100 may determine whether to turn on or turn off the partition dimming function of the partition-driven backlight module 1 according to the brightness of ambient light. That is, when the brightness of ambient light detected by the detector 4 is greater than or equal to a set value, indicating that the ambient light may cause poor contrast of the electronic device 100 and affect the display quality, the partition dimming function of the partition-driven backlight module 1 is thus turned on to improve the contrast of the electronic device 100. When the brightness of ambient light detected by the detector 4 is smaller than the set value, indicating that the ambient light has little effect on the contrast of the electronic device 100, the partition dimming function of the partition-driven backlight module 1 is thus turned off. Therefore, the display quality of the electronic device 100 may be improved through the above driving method.

In the present disclosure, the electronic device 100 may be, for example, any one of FIG. 1 to FIG. 3, and will not be described in detail herein. In the present disclosure, the partition-driven backlight module 1 may be, for example, as shown in FIG. 4 or FIG. 5, and the partition-driven backlight module 1 may have a partition dimming function as described above, which will not be described in detail herein. In the present disclosure, the electronic device 100 may be applied to, for example, a car display as shown in FIG. 6B and a consumer electronic product (a notebook computer as shown in FIG. 6C or a mobile phone as shown in FIG. 6D, but not limited thereto), etc., but the present disclosure is not limited thereto.

In one embodiment of the present disclosure, as shown in FIG. 6B to FIG. 6D, the electronic device 100 may include a main body M, and the main body M has a display area AA and a non-display area B, wherein the non-display area B is arranged around the display area AA, and the detector 4 may be arranged adjacent to the non-display area B to detect the brightness of ambient light. In one embodiment of the present disclosure, as shown in FIG. 6B, the detector 4 may be disposed outside the main body M of the electronic device 100, but the present disclosure is not limited thereto. For example, in other embodiments, as shown in FIG. 6C and FIG. 6D, the detector 4 may be embedded in the main body M of the electronic device 100 and disposed corresponding to the non-display area B. The “main body M” refers to, for example, components including the partition-driven backlight module 1, the privacy-adjustable element 2, the panel 3, and the polarizing plate 5 as shown in FIG. 1 to FIG. 3, but the present disclosure is not limited thereto.

In one embodiment of the present disclosure, as shown in FIG. 6B, when the electronic device 100 is applied to a multi-screen display, such as a car display for driver or passenger, the display area AA of the electronic device 100 may include a first portion AA1 and a second portion AA2, and the non-display area B is arranged around the first portion AA1 and the second portion AA2, respectively. The first portion AA1 may be provided to the driver and the second portion AA2 may be provided to the passenger. When the electronic device 100 is switched to the sharing mode, the driver may, for example, view the display images of the first portion AA1 and the second portion AA2 of the display area AA. When the electronic device 100 is switched to the privacy mode, the driver may, for example, only clearly view the display image of the first portion AA1, but cannot clearly view the display image of the second portion AA2, while it is not limited thereto.

In one embodiment of the present disclosure, as shown in FIG. 6B to FIG. 6D, the electronic device 100 may selectively include a control button C, which is disposed corresponding to the non-display area B. The control button C may be used to control the partition dimming function of the partition-driven backlight module 1, that is, the user may manually control to turn on or turn off the partition dimming function of the partition-driven backlight module 1 as needed.

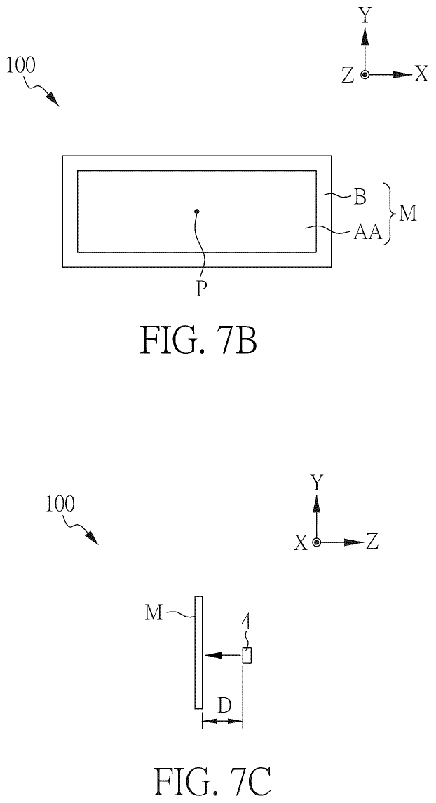

FIG. 7A is a block diagram of a driving method of an electronic device according to an embodiment of the present disclosure. FIG. 7B and FIG. 7C are schematic diagrams showing a detector detecting the contrast of an electronic device according to an embodiment of the present disclosure. The driving method of FIG. 7A is similar to that of FIG. 6A, except for the following differences.

In one embodiment of the present disclosure, referring to the electronic device of FIG. 1 to FIG. 3, as shown in FIG. 7A, the electronic device 100 of the present disclosure may determine to turn on or turn off the privacy mode according to user needs, that is, by switching the privacy-adjustable element 2 to the privacy mode or the sharing mode to turn on or turn off the privacy mode of the electronic device 100. When the privacy-adjustable element 2 is switched to the sharing mode (that is, the electronic device 100 turns off the privacy mode), the electronic device 100 may turn on the partition dimming function of the partition-driven backlight module 1, thereby improving the contrast of the electronic device 100. When the privacy-adjustable element 2 is switched to the privacy mode (that is, the electronic device 100 turns on the privacy mode), the electronic device 100 may determine whether to turn on or turn off the partition dimming function of the partition-driven backlight module 1 according to the contrast of the electronic device 100. That is, when the contrast of the electronic device 100 detected by the detector 4 is smaller than a set value, indicating that the poor contrast of the electronic device 100 affects the display quality, the partition dimming function of the partition-driven backlight module 1 is thus turned on to improve the contrast of the electronic device 100. When the contrast of the electronic device 100 detected by the detector 4 is greater than or equal to the set value, the partition dimming function of the partition-driven backlight module 1 is turned off. Therefore, the display quality of the electronic device 100 may be improved through the above driving method.

In the present disclosure, the electronic device 100 may be, for example, any one of FIG. 1 to FIG. 3, and the electronic device 100 may be applied to a car display as shown in FIG. 6B or a consumer electronic product as shown in FIG. 6C to FIG. 6D, which will not be described in detail herein. In the present disclosure, the partition-driven backlight module 1 may be, for example, as shown in FIG. 4 or FIG. 5, and the partition-driven backlight module 1 may have a partition dimming function as described above, which will not be described in detail herein.

In one embodiment of the present disclosure, as shown in FIG. 7B and FIG. 7C, when the detector 4 is used to detect the contrast of the electronic device 100, a distance D may be spaced between the detector 4 and the main body M of the electronic device 100. More specifically, in the normal direction Z of the electronic device 100, a distance between the main body M of the electronic device 100 and the detector 4 is the distance D. The detector 4 is, for example, used to detect the contrast of the approximate center point P of the display area AA of the electronic device 100, but it is not limited thereto. In the present disclosure, the distance D is not particularly limited and may be adjusted according to the type of the electronic device 100 and the type of the detector 4. In the present disclosure, the “contrast of the electronic device 100” refers to, for example, the ambient contrast ratio of the electronic device 100 or the darkroom contrast ratio of the electronic device 100, that is, the contrast of the electronic device 100 in the presence of ambient light or the contrast of the electronic device 100 in the absence of ambient light (such as a car display inside a car at night, etc.).

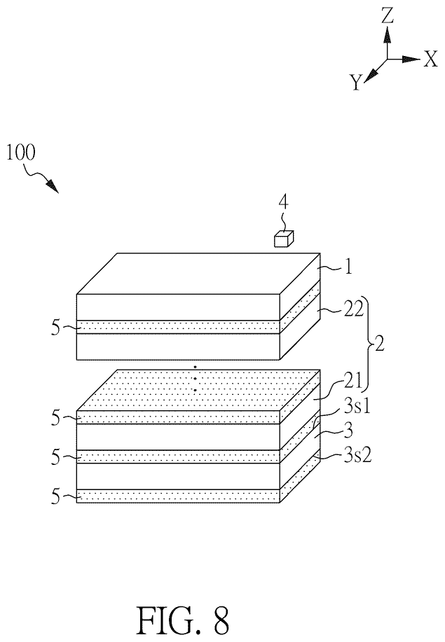

FIG. 8 is a schematic diagram of an electronic device according to another embodiment of the present disclosure. The electronic device of FIG. 8 is similar to that of FIG. 1, except for the following differences.

In one embodiment of the present disclosure, as shown in FIG. 8, the partition-driven backlight module 1 is arranged on a privacy-adjustable element 2 and a panel 3 (a reflective panel, such as a cholesterol liquid crystal panel or an electronic ink panel), and the privacy-adjustable element 2 is arranged between the partition-driven backlight module 1 and the panel 3. In one embodiment of the present disclosure, as shown in FIG. 8, the partition-driven backlight module 1 is disposed on the display side 3s1 of the panel 3, that is, the display side 3s1 of the panel 3 is adjacent to the partition-driven backlight module 1 relative to the non-display side 3s2.

In one embodiment of the present disclosure, as shown in FIG. 8, the detector 4 is disposed adjacent to the partition-driven backlight module 1, that is, the detector 4 may be disposed adjacent to the partition-driven backlight module 1 in comparison to the panel 3. In one embodiment of the present disclosure, as shown in FIG. 8, the detector 4 is disposed on the display side 3s1 of the panel 3, that is, the display side 3s1 of the panel 3 is adjacent to the detector 4 relative to the non-display side 3s2.

In the present disclosure, the detailed features of the partition-driven backlight module 1, the privacy-adjustable element 2, the panel 3, the detector 4 and the polarizing plate 5 are as described above and will not be repeated here. In addition, other detailed features of the partition-driven backlight module 1 and the partition dimming function may be as described in FIG. 4 and FIG. 5, which will not be described in detail herein.

In the present disclosure, by combining a partition-driven backlight module 1 with a privacy-adjustable element 2, the electronic device 100 may be switched between a privacy mode and a sharing mode. In addition, by turning on or turning off the partition dimming function of the partition-driven backlight module 1, the display quality and/or power saving effect of the electronic device 100 may be improved.

The aforementioned specific embodiments should be construed as merely illustrative, and not limiting the rest of the present disclosure in any way.

1. A driving method of an electronic device, comprising:
providing an electronic device including a panel, a partition-driven backlight module, and an privacy-adjustable element, wherein the privacy-adjustable element is disposed on one side of the partition-driven backlight module, the panel is disposed on one side of the privacy-adjustable element, the partition-driven backlight module has a partition dimming function, and the privacy-adjustable element is capable of being switched to a privacy mode or a sharing mode; and
providing a detector for detecting a brightness of ambient light or a contrast of the electronic device,
wherein, when the privacy-adjustable element is switched to the sharing mode, the partition-driven backlight module turns on the partition dimming function,
wherein, when the privacy-adjustable element is switched to the privacy mode, the partition-driven backlight module turns on or turns off the partition dimming function according to the brightness of ambient light or the contrast of the electronic device detected by the detector.

2. The driving method as claimed in claim 1, wherein, when the privacy-adjustable element is switched to the privacy mode, the partition-driven backlight module turns on the partition dimming function when the brightness of ambient light detected by the detector is greater than or equal to a set value, and the partition-driven backlight module turns off the partition dimming function when the brightness of ambient light detected by the detector is smaller than the set value.

3. The driving method as claimed in claim 1, wherein, when the privacy-adjustable element is switched to the privacy mode, the partition-driven backlight module turns on the partition dimming function when the contrast of the electronic device detected by the detector is smaller than a set value, and the partition-driven backlight module turns off the partition dimming function when the contrast of the electronic device detected by the detector is greater than or equal to the set value.

4. The driving method as claimed in claim 1, wherein the partition-driven backlight module includes multiple adjustment sections, each having at least one light emitting unit, wherein, when the privacy-adjustable element is switched to the sharing mode, the at least one light emitting unit in the multiple adjustment sections corresponding to a display screen area of the panel is turned on, and the at least one light emitting unit in the multiple adjustment sections not corresponding to the display screen area of the panel is not turned on.

5. An electronic device, comprising:
a partition-driven backlight module;
a privacy-adjustable element disposed on one side of the partition-driven backlight module, wherein the privacy-adjustable element is capable of being switched to a privacy mode and a sharing mode; and
a panel disposed on one side of the privacy-adjustable element.

6. The electronic device as claimed in claim 5, further comprising a detector disposed adjacent to the panel or the privacy-adjustable element for detecting a brightness of ambient light or a contrast of the electronic device.

7. The electronic device as claimed in claim 5, wherein the privacy-adjustable element is disposed between the panel and the partition-driven backlight module.

8. The electronic device as claimed in claim 5, wherein the panel is disposed between the privacy-adjustable element and the partition-driven backlight module.

9. The electronic device as claimed in claim 5, wherein the privacy-adjustable element includes a first portion and a second portion respectively disposed on two sides of the panel.

10. The electronic device as claimed in claim 5, wherein the partition-driven backlight module includes multiple adjustment sections, each having at least one light emitting unit, wherein, when the privacy-adjustable element is switched to the sharing mode, the partition-driven backlight module turns on the partition dimming function, the at least one light emitting unit in the multiple adjustment sections corresponding to a display screen area of the panel is turned on, and the at least one light emitting unit in the multiple adjustment sections not corresponding to the display screen area of the panel is not turned on.

11. The electronic device as claimed in claim 7, wherein the privacy-adjustable element includes a first portion and a second portion, wherein the second portion is disposed on the first portion, and the first portion and the second portion are both disposed between the panel and the partition-driven backlight module.

12. The electronic device as claimed in claim 9, wherein the first portion of the privacy-adjustable element includes a first sub-portion and a second sub-portion disposed on the first sub-portion, and the first sub-portion and the second sub-portion are both disposed between the partition-driven backlight module and the panel, and wherein the second portion of the privacy-adjustable element includes a third sub-portion and a fourth sub-portion disposed on the third sub-portion, and the third sub-portion is disposed between the panel and the fourth sub-portion.

13. The electronic device as claimed in claim 10, wherein, in a normal direction of the panel, the partition-driven backlight module turns on at least one light emitting unit of the multiple adjustment sections at least partially overlapping with the display screen area, and turns off at least one light emitting unit of the multiple adjustment sections not overlapping with the display screen area.

14. The electronic device as claimed in claim 10, wherein the partition-driven backlight module includes a light guide plate having a light incident surface and a light existing surface connected to the light incident surface, the at least one light emitting unit is disposed corresponding to the light incident surface of the light guide plate, and the panel is disposed corresponding to the light existing surface of the light guide plate.

15. The electronic device as claimed in claim 5, further comprising at least one polarizing plate at least disposed on two sides of the panel, two sides of the privacy-adjustable element, between the panel and the privacy-adjustable element, or between the privacy-adjustable element and the partition-driven backlight module.

16. The electronic device as claimed in claim 5, wherein the electronic device is provided with a main body including the partition-driven backlight module, the privacy-adjustable element and the panel, the main body has a display area and a non-display area, the non-display area is disposed around the display area, and the detector is disposed adjacent to the non-display area.

17. The electronic device as claimed in claim 5, wherein the electronic device is provided with a main body including the partition-driven backlight module, the privacy-adjustable element and the panel, the main body has a display area and a non-display area, the non-display are is disposed around the display area, and in a normal direction of the electronic device, there is a distance between the detector and the main body for detecting a contrast of the display area.

18. The electronic device as claimed in claim 5, wherein the partition-driven backlight module is disposed on the panel and the privacy-adjustable element.

19. The electronic device as claimed in claim 18, further comprising a detector disposed adjacent to the partition-drivable backlight module, and the detector is capable of detecting a brightness of ambient light or a contrast of the electronic device.

20. The electronic device as claimed in claim 19, wherein the panel has a non-display side and a display side opposite to the non-display side, and the partition-driven backlight module and the detector are disposed on the display side of the panel.
